(19) United States
(12) Patent Application Publication
(10) Pub. No.: US 2002/0142690 A1
(43) Pub. Date: Oct. 3, 2002

(54) Cleansing wipe

(76) Inventor: Michael David Wilson, Encino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,810

(22) Filed: Mar. 30, 2001

(51) Int. Cl. B32B 5/02; B32B 27/04; B32B 27/12; D04H 1/00; D04H 13/00

(52) U.S. Cl. 442/400; 442/327; 442/96; 442/123

(57) ABSTRACT

An apparatus comprising a substrate comprising an absorbent material and a composition contained within the substrate, the composition comprising at least an antibacterial agent and a spermicidal agent.

### FIELD OF THE INVENTION

The invention is directed to “single-use” personal care wiping products.

### BACKGROUND

Disposable wipe products are widely used in both the home and in industrial shops to replace conventional cloth wipes and towels, which are used to clean up common contaminants around the home and workplace. However, such wipes are not specifically designed to remove intimate contaminants. Intimate contaminants include, but are not limited to, blood, lubricants, semen, vaginal fluid, urine and fecal matter. There is a large market of wiping products directed towards cleaning and removing urine and fecal matter from babies and a small market of wipes directed towards feminine cleaning. Products directed towards baby and feminine markets contain solutions which are generally unsuitable for killing sperm, bacteria and sexually transmitted diseases. For instance, semen is one of the more tenacious soils and is particularly difficult to remove from a human body without showering. Conventional cleaning with towels or tissue is not effective in the complete removal of semen, vaginal fluid, blood and lubricants. Further, individuals often subject themselves to sexually transmitted diseases and even pregnancy without proper removal of these bodily fluids.

Spermicidal compositions are useful for protection against pregnancy and sexually transmitted diseases. They can be used alone, with a mechanical barrier-type device (such as a diaphragm, cap, or sponge) or as an adjunct to other contraceptive methods (such as birth control pill, intra-uterine-device, or rhythm). These compositions generally contain a spermicidal chemical that kills sperm and a base or carrier, such as a foam, cream, gel, suppository, or tablet. Nonoxynol-9 and octoxynol (octoxynol-9) are the only two spermicidal agents available in the United States. Both are surfactants that destroy the sperm cell membrane. Other surfactant products, including menfegol and benzalkonium chloride, are available in other parts of the world.

Spermicidal agents are also microbicides. They are lethal to microorganisms, including those that cause sexually transmitted diseases, such as gonorrhea, chlamydia, genital herpes, trichomonas, and syphilis. Spermicides are known to prevent transmission of these sexually transmitted diseases. While spermicides have been found to be toxic in vitro to the Human Immunodeficiency Virus (HIV), the relationship between spermicide use and HIV risk is still not understood. Protection against sexually transmitted diseases is probably the most important non-contraceptive benefit of spermicide use, and, according to some studies, this protection extends to decreased risk of HIV and Acquired Immune Deficiency Syndrome (AIDS).

### DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a perspective view of a wipe in accordance with one embodiment.

FIG. 2 is an exploded view of a wipe in accordance with another embodiment.

### DETAILED DESCRIPTION

Various embodiments described herein overcome the problems in the existing art described above by providing an apparatus including, in one embodiment, a substrate and a composition within the substrate comprising at least an antibacterial agent and a spermicidal agent. In the following description, for the purposes of explanation, numerous specific details are set forth in order to provide a thorough understanding of the embodiments described. It will be apparent, however, to one skilled in the art that the various embodiments may be practiced without some of these specific details. The following description and the accompanying drawings provide examples for the purposes of illustration. However, these examples should not be construed in a limiting sense as they are merely intended to provide exemplary embodiments rather than to provide an exhaustive list of all possible implementations. In other instances, well-known structures and methods have been omitted to avoid obscuring the details of the described embodiments.

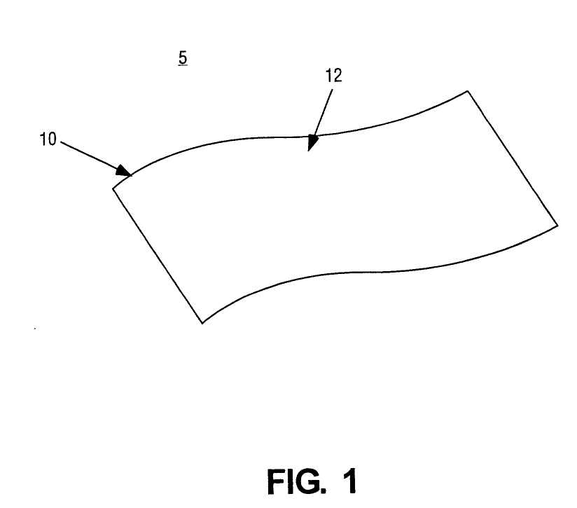

FIG. 1 shows a wipe 5 including substrate 10 with solution 12 disposed in or on substrate 10. Substrate 10 is for example a handheld wipe having dimensions on the order of three inches by four inches. In one embodiment, the solution 12 comprises a composition of at least an antibacterial agent and a spermicidal agent. The spermicidal agent can be, for instance, nonoxynol-9. Article 5 provides an effective wipe for removing intimate contaminants such as semen, vaginal fluid, blood, lubricants, urine and fecal matter. Wipe 5 can be conveniently carried in a purse or pocket, so that a consumer need never be without the intimate care product.

Substrate 10 of wipe 5 may be comprised of a number of different materials which are suitable as a substrate. According to an embodiment, substrate 10 can be of a material similar to that described in U.S. Pat. No. 5,284,703 to Kimberly-Clark Corporation entitled “High Pulp Content Non-Woven Composite Fabric” which is herein incorporated by reference. Such substrates are available from Kimberly-Clark Corporation under the HYDROKNIT trademark. According to another embodiment, the substrate 10 can be a melt-blown wipe similar to that described in U.S. Pat. No. 4,659,609 to Kimberly-Clark Corporation entitled “Abrasive Web and Method of Making Same” which is herein incorporated by reference.

Various embodiments of substrate 10 provide a fabric web having at least one abrasive cleaning surface suitable for an intimate wipe and which is compatible with the cleaning solution. As used herein, the term “abrasive” refers to a surface texture that enables the towel to produce a very mild scouring or abrading action to effectively remove contaminants, including, but not limited to blood, semen, and vaginal fluid. Of course, the degree of abrasiveness can be controlled and may vary widely depending upon the desired end use.

In various embodiments, wipe 5 is capable of absorbing and retaining an effective amount of cleaning solution so as to provide a uniformly moist article. In one representative example, the absorbent character of the wipe retains the solution by capillary action and readily releases the solution during use. Any wipes with absorbent qualities may be employed.

One composition suitable for use on wipe 5 includes a solution for cleaning intimate contaminants such as semen, vaginal fluid, blood, and lubricants. The combination of a wipe infused with a composition including a solution of an antibacterial agent and a spermicidal agent has been found to offer an improved intimate wipe.

According to an embodiment of the invention, a suitable spermicidal agent of the composition includes nonoxynol-9 or its derivatives. Any spermicidal chemical is suitable for incorporation into the composition, including nonoxynol-9, octoxynol (octoxynol-9) or a combination of nonoxynol-9 and octoxynol, which are the only two spermicidal agents currently available in the United States. Nonoxynol-9 is the most commonly used spermicide in the United States due to its safety and efficacy. It is known to prevent the transmission of sexually transmitted diseases. In the laboratory, it is lethal to the HIV virus. Both nonoxynol-9 and octoxynol are surfactants that destroy the sperm cell membrane. Other spermicides, whether acting as surfactants or through other mechanisms of action, are contemplated. For example, menfegol and benzalkonium chloride, which are spermicides and surfactants, and which are available in other parts of the world, are likewise suitable. Spermicides that act to prevent transmission or reduce the risk of one or more sexually transmitted diseases, such as gonorrhea, chlamydia, genital herpes, trichomonas, and syphilis, are contemplated. It is believed these spermicides are lethal to agents that cause these diseases because they are surfactants, but other mechanisms of action are contemplated. It is advantageous that the microbicidal spermicides of the invention protect against the transmission of HIV and decrease the risk of AIDS.

The concentration of spermicidal agent will vary depending on the base or carrier, but in one embodiment the amount will fall within the parameters of about one percent to about twenty-eight percent by weight of a composition in or on substrate 10 of wipe 5. At lower concentrations (e.g., less than one percent), it is believed there will not be enough spermicidal agent to kill the sperm. At higher concentrations (i.e., greater than thirty percent), the spermicidal agent can irritate and even damage the vaginal epithelium. In another embodiment, the spermicidal agent is combined with the base or carrier that is a gel. In one example with a composition including spermicidal agent and carrier, the spermicide concentration will range from about one percent to about five percent by weight of the composition. In another embodiment, the composition includes three percent by weight spermicidal agent.

Various embodiments of the invention include a composition that further includes an antibacterial agent such as triclosan. Triclosan is a broad-spectrum antibacterial/antimicrobial agent. It is manufactured in the United States by Ciba-Geigy, under their trade name IRGASAN DP300, and by several other manufacturers outside of the United States. As a result of its bacteriostatic activity against a wide range of both gram-negative and gram-positive bacteria, it has found increasing and recent popular use in personal care products, such as toothpaste, deodorant soaps, deodorants, antiperspirants and body washes, detergents, dish washing liquids, cosmetics and anti-microbial creams, lotions and hand soaps. Triclosan is also used as an additive in plastics, polymers and textiles to give these materials antibacterial properties. Other useful antibacterial agents include, but are not limited to, benzethonium chloride and herbally-derived agents such as tea tree extracts. A combination of antibacterial agents is also suitable. The amount of antibacterial agent in the composition may vary as known in the art. In one embodiment, the amount of antibacterial agent in a composition including a spermicidal agent is on the order of one to twenty-five percent by weight of the composition.

In various embodiments, the composition used with the wipes will include aloe vera. The composition and manner of action of aloe vera is not fully understood. It has been reported that steroids and wound-healing hormones may be contained in aloe vera, but it is more commonly believed that the moisturizing emollient and healing properties of aloe vera are due to the polysaccharides present, or to synergistic effects of the polysaccharides and other substances present in the gel. See Leun, A.; Effective Ingredients of Aloe Vera, Drugs & Cosmetics, June 1977, pp. 34-5 and 154-5, the cited portions of which are incorporated herein by reference.

Aloe vera is also known to have antibacterial properties, as disclosed by Lorenzetti, et. al., J. Pharm. Sci. 53, 1287 (1964), which is incorporated herein by reference. A list of species of aloe which have therapeutic value can be found in U.S. Pat. No. 4,646,029 (Grollier et al.), the entire text of which is incorporated herein by reference. U.S. Pat. No. 4,857,328 (Trenzeluk) teaches an anti-burn mixture containing aloe, petroleum (Example 1) and cetyl alcohol (Example 3). U.S. Pat. No. 5,118,673 (Carpenter et al) provides an extensive discussion of the history, biological properties, and pharmacy of aloe products, which is incorporated herein by reference. U.S. Pat. No. 5,118,673 discusses rapid healing of radiation bums with aloe vera gel.

An embodiment of the composition may additionally include modifiers which change the solubility properties, impart fragrance and/or color, modify feel both during dissolution and after use, and which increase or decrease dimensional stability of the product. Suitable modifiers include, but are not limited to, water, propylene glycol, sodium coco pg, dimonium chloride, phosphate, cetyl hydroxyethykellulose, methylparaben, and propylparaben.

Fragrance substances or agents may also be added to the composition. If added, substances used to produce a desired fragrance may be any one or more of those which are commonly used by those skilled in the art of toiletry fragrance chemistry or perfumery, some of which are listed in the following texts: Robert R. Calkin, J. Stephan Jellinek, Perfumery, Practice and Principle, John Wiley and Sons, Inc., New York, 1994; Rudiger Hall, Dieter Klemme, Jurgen Nienhaus, Guide to Fragrance Ingredients, H&R Edition, R. Gross & Co. Publishing, Hamburg, 1985; Julia Muller, The H&R Book of Perfume, H&R Edition, Johnson Publications, Ltd., London, 1984; Fragrance Guide-Feminine Notes, Masculine Notes, H&R Edition, R. Gross & Co. Publishing, Hamburg, 1985, all of which are incorporated by reference herein. Embodiments of suitable compositions are not to be limited to any particular fragrance substance or combination of fragrance substances, since generally any non-toxic fragrance or chemical substances which humans find pleasant and desirable to inhale are contemplated.

The amount of fragrance substance (e.g., perfume base) included in the composition may vary, and the amount of the fragrance substance may comprise from about 0.01 percent to about ten percent by weight of the total cosmetic or cleansing composition, with about 0.5 percent to about one percent being preferred. Quantities of fragrance outside of this preferred range may also be used, as well as significantly larger amounts.

The composition may further include a coloring agent, preferably a water-soluble coloring agent, to impart color to the final product. Examples of colorants include Food, Drug and Cosmetic Agency approved colors. It is generally preferred to use small amounts of dyes, and to use dyes which do not react with skin, hair or fabric.

The composition may be applied to the wipes in several different ways. For example, the composition may be applied to the wipe by dipping the wipes in the composition and/or spraying them with the composition to ensure even distribution of the composition. Any common practice for impregnating wipes is contemplated.

Further, the cleaning composition as described is generally non-toxic and is proven safe when applied directly to human skin.

Various embodiments are ideally designed to be water soluble, colorless, stainless, and greaseless. One such embodiment combines the following ingredients by weight: nonoxynol-9 (about 3%) and triclosan (about 3%) with purified water (about 65%-75%) as a diluent and vehicle, propylene glycol (about 1%-25%), sodium coco pg (about 1%-25%), dimonium chloride (about 1%-25%), phosphate (about 1%-25%), cetyl hydroxythellulose (about 1%-25%), aloe (about 1%-25%), polyacrylamide (about 1%-5%), C13-14 isoparaffin and laureth-7 (about 1.0%-5.0%) as gelling agent, lactic acid (about 0.5%-2.5%) for acidification, simethicone (about 0.1%-0.8%) as a defoamer, and potassium sorbate (about 0.1%-0.5%), methlyparaben (about 0.1%-0.3%), and propylparaben (about 0.1%-0.3%) as preservatives.

The described wipe 5 is useful in a variety of applications. Wipe 5 is highly effective at removing intimate contaminants from an individual's skin. Further, wipe 5 provides a good cleaning article for contaminated articles such as clothing, bedding, and hard, non-porous surfaces including metal, tile, sealed concrete, and painted surfaces.

Various embodiments have further utility as a stain remover or pre-treatment for fabric surfaces. The infused wipes can be used to blot and remove intimate contaminants from clothing and fabric. Where immediate removal is not achieved using the wipe, the wipe effectively transfers the cleaning composition to the contaminated area. Thereafter, it is believed the cleaning solution/contaminant stain will emulsify and separate upon further cleaning with water or detergent.

Wipes, such as wipe 5, lend themselves to packaging in pull-out type dispensers as well as single, sealed foil-packaged wipes. By way of example, the latter can be used as promotional items or as a consumer premium which accompanies the retail sale of condoms. In a single foil package, a wipe such as wipe 5 may be folded to reduce its size to, for example, a two-inch square single foil package.

Various embodiments of the wipe (such as wipe 5) contain a sufficient amount of cleaning composition to remove intimate contaminants such as semen, vaginal fluid, blood, and lubricants from an individual's skin and surrounding environment. As the wipe is rubbed on the surface to be cleaned, it releases sufficient cleaning formula which makes contact with the contaminant. The wipe also provides a light abrasive action and a reabsorption capability to remove the contaminant by the wiping action. In an embodiment, a non-woven polypropylene wipe will avoid re-depositing the contaminant upon the surface which is being cleaned.

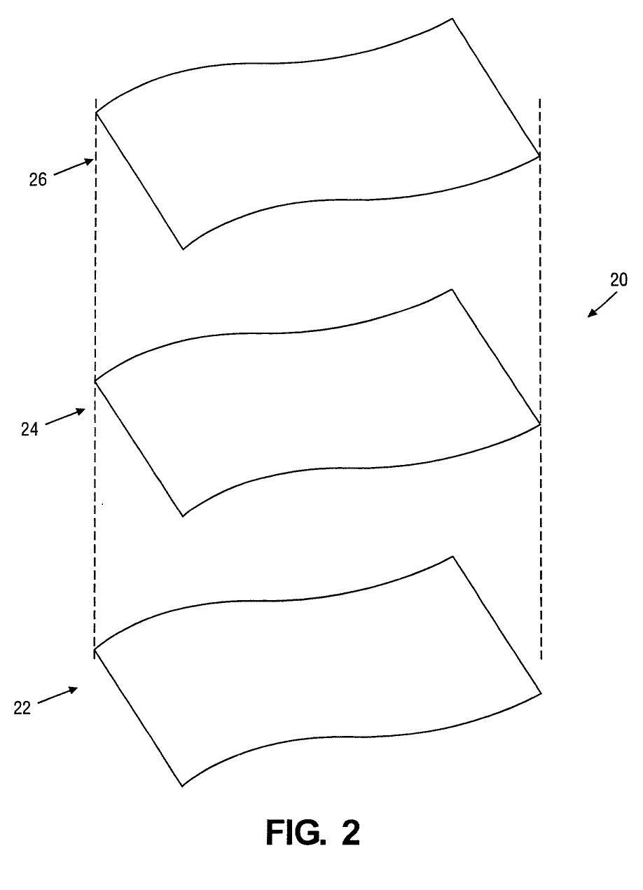

FIG. 2 shows another embodiment which comprises a first substrate 22 and a second substrate 26 separated by a non-permeable layer 24, such as plastic material. One substrate of the wipe contains the spermicidal agent while the other substrate contains the antibacterial agent. Each side may be denoted by any identifiable indicator. For instance, color and/or wording can signify which side of the wipe contains the spermicidal agent and which side contains the antibacterial agent. The purpose of this embodiment is to separate the two or more respective solutions if there is any chemical conflict between them.

The method of using the wipe, regardless of the embodiment, is generally the same. For instance, a user, holding a wipe having a substrate and a composition having at least a spermicidal agent disposed thereon, wipes an area contaminated with at least one intimate contaminant, such as semen, vaginal fluid, blood, lubricants, or the like. For example, the contaminated area could be any portion of the human body or any other surface which may have been contaminated. If the wipe is of the two-sided embodiment, a user could first wipe the contaminated area with one side and then with the other. For example, the user could first wipe the contaminated area with the side having a spermicidal agent in the composition and subsequently wipe the contaminated area with the side having an antibacterial agent in the composition. It should also be noted that the wiping methods described herein may be conducted before or after sexual activity or both.

One advantage of an embodiment is that when used for cleaning skin, the skin is left with a moisturizing residue of aloe and does not require any additional cleaning with soap and water. The cleaning properties are further enhanced by the presence of the antibacterial properties of triclosan.

Additionally, the cleaning formulation is self-emulsifying in the presence of water. As such, it is a simple matter to remove the residue from the skin or other cleaned surfaces. Further, the presence of small amounts of water on or adjacent to the surface to be cleaned does not adversely affect the cleaning efficiency.

Various embodiments offer numerous advantages over typical cleaning products for intimate contaminants. In fact, a good argument can be made that an intimate contaminant disposal mechanism has never been addressed. Various embodiments described herein provide a useful cleaning wipe, which may be handled safely by the user, using a solution that is pleasantly scented, is non-toxic, and, even if misused or misapplied, poses little or no risk to the end user. Further, the wipe product is believed to be far more effective at removing stubborn, and many times embarrassing, intimate contaminants and preventing the spread of sexually transmitted diseases and pregnancy than any other cleaning formulation suitable for use as an intimate wipe.

It is to be understood that even though numerous characteristics and advantages of various embodiments have been set forth in the foregoing description, together with details of the structure and function of various embodiments, this disclosure is illustrative only. Changes may be made in detail, especially matters of structure and composition, without departing from the scope of the invention as expressed by the broad general meaning of the terms of the appended claims.

I claim:

1. An apparatus comprising:
a substrate comprising an absorbent material; and
a composition contained within the substrate, the composition comprising at least an antibacterial agent and a spermicidal agent.

2. The apparatus of claim 1, wherein the substrate comprises at least one of a paper, a high pulp content non-woven composite fabric, and an abrasive polypropylene meltblown web.

3. The apparatus of claim 1, wherein the composition further comprises a moisturizer.

4. The apparatus of claim 1, wherein the composition further comprises at least one substance to impart a fragrance to the apparatus.

5. The apparatus of claim 1, wherein the antibacterial agent comprises at least one of triclosan, benzethonium chloride, and a tea tree extract.

6. The apparatus of claim 1, wherein the spermicidal agent comprises at least one of nonoxynol-9, octoxynol, menfegol, and benzalkonium chloride.

7. An apparatus comprising:
a first substrate capable of disposing solution therein;
a second substrate capable of disposing solution therein;
a non-permeable layer disposed between the first substrate and the second substrate;
a first composition comprising at least an antibacterial agent disposed in the first substrate; and
a second composition comprising at least a spermicidal agent disposed in the second substrate.

8. The apparatus of claim 7, further comprising:
a first identifiable indicator on the first substrate; and
a different second identifiable indicator on the second substrate.

9. The apparatus of claim 7, wherein the first substrate and the second substrate each comprise at least one of a paper, a high pulp content non-woven composite fabric, and an abrasive polypropylene meltblown web.

10. The apparatus of claim 7, wherein the non-permeable layer comprises a plastic material.

11. The apparatus of claim 7, wherein at least one of the first composition and the second composition comprises aloe vera.

12. The apparatus of claim 7, wherein at least one of the first composition and the second composition comprises at least one coloring agent.

13. The apparatus of claim 7, wherein the antibacterial agent comprises at least one of triclosan, benzethonium chloride, and a tea tree extract.

14. The apparatus of claim 7, wherein the spermicidal agent comprises at least one of nonoxynol-9, octoxynol, menfegol, and benzalkonium chloride.

15. A method comprising:
providing a substrate comprising an absorbent material; and
introducing each of a spermicidal agent and an antibacterial agent onto the substrate.

16. The method of claim 15, wherein introducing comprises dipping the substrate into at least one solution containing at least one of the spermicidal agent and the antibacterial agent.

17. The method of claim 15, wherein introducing comprises spraying the substrate with at least one solution containing at least one of the spermicidal agent and the antibacterial agent.

18. A method comprising:
providing an article comprising a substrate having dimensions suitable to be operated by a human hand, the substrate having disposed therein or thereon a composition including a spermicidal agent; and
wiping an area contaminated with at least one intimate contaminant with a portion of the article.

19. The method of claim 18, wherein the composition further includes an antibacterial agent.

20. The method of claim 18, wherein the substrate comprises a first side portion and a second side portion and the composition comprises a first composition, the method further includes:
providing an article with a second composition comprising an antibacterial agent on the second side portion; and
after wiping an area of the human body with the first side portion of the article, wiping the area with the second side portion of the article.
